(19) United States
(12) Patent Application Publication
(10) Pub. No.: US 2020/0316991 A1
(43) Pub. Date: Oct. 8, 2020

(54) LEVEL CASTOR

(71) Applicant: Sin Dong YEO, Daegu (KR)

(72) Inventor: Sin Dong YEO, Daegu (KR)

(21) Appl. No.: 16/756,293

(22) PCT Filed: Jul. 27, 2018
(86) PCT No.: PCT/KR2018/008558

§ 371 Date: Apr. 15, 2020

(30) Foreign Application Priority Data
Nov. 16, 2017 (KR) 10-2017-0152822

(51) Int. Cl. B60B 33/06; F16H 25/20; F16H 1/12; B60B 33/00

(52) U.S. Cl. CPC B60B 33/063; F16H 25/20; F16H 1/12; B60B 33/0076; F16H 2025/2084; B60B 33/0049; B60B 33/0068

(57) ABSTRACT

Disclosed is a level castor including: a castor main body which has a socket shape having an opening, and in which a wheel contacting the ground is mounted therein and rotatably hinge-coupled to one portion of the lower side thereof; a connection frame which is rotatably connected to the castor main body and fixedly mounted to a weight disposed thereabove, thereby connecting the castor main body to the weight such that the castor main body can rotate with respect to the weight; a support body provided to the castor main body through the opening in a retractable manner so as to contact the ground; and an adjustment unit which is provided in an inner accommodation space of the castor main body, and which retracts the support body through a rotation operation of a rotation handle.

### CROSS REFERENCE TO PRIOR APPLICATIONS

This application is a National Stage Patent Application of PCT International Patent Application No. PCT/KR2018/008558 (filed on Jul. 27, 2018) under 35 U.S.C. § 371, which claims priority to Korean Patent Application No. 10-2017-0152822 (filed on Nov. 16, 2017), which are all hereby incorporated by reference in their entirety.

### BACKGROUND

The present disclosure relates to a castor, and more specifically, to a leveling castor that allows a non-skilled person to perform leveling more easily than in a conventional castor.

In general, a castor refers to a small wheel that is installed on a bottom of a furniture leg to allow a person to move heavy furniture more easily.

In addition, the castor has the movement function and a vertical level adjustment function in order to stably an fixedly support the furniture at a certain place.

The castor may move to a target position using a wheel. Then, a user rotates a handle so that a support member contacts a floor surface. Thus, the castor may support the furniture on the floor.

Therefore, a prior art castor proposed in Patent Document 1 includes a switch member, an elastic member, a case and a tooth wheel rotating member. The switch member has a first hook portion making a tooth wheel rotate only to one direction and a second hook portion making the tooth wheel rotate only to the other direction. The elastic member elastically pushes the switch member toward a selected direction. The case has a switch member supporting portion and an elastic member installing portion on the one side surface thereof, and a handle accommodating member on the other side surface thereof. The tooth wheel rotating member is equipped with a handle which makes the case rotated even with a little force. To lift a supporting plate, the left end of the switch member is pushed to inside to make the first hook portion hooked to a toothed wheel. The elastic member pushes the switch member clockwise. A handle is pulled off from a body and rotated to transmit power to the toothed wheel which rotates unidirectionally to lift the supporting plate. In this castor, configurations of the switch member and the elastic member are complicated. Thus, it is difficult to manufacture and assemble the castor.

To solve this problem, a prior art castor as proposed in Patent Document 2 includes a gear having a plurality of gear grooves around the gear; and a torque transmission device which is disposed at a circumference of the gear and selects a transmission direction of torque with respect to the gear to transmit the torque. The torque transmission device comprises: an adjustment lever which enables to rotate between the first and the second position; a position adjustment member which presses the adjustment lever elastically to be in one position among a first position or a second position. The adjustment lever can be positioned at the same gear groove in the first and the second position, and the torque transmission device can transmit the torque in a selected direction to the gear when the adjustment lever is at one position of the first or the second position.

Therefore, the castor of Patent Document 2 is simpler in terms of construction and is easily installed than the castor of Patent Document 1, and thus a production cost of the former may be reduced. However, in leveling a weight on the castor, a leveling displacement is too small compared to an force by which an user holds the handle and repeatedly reciprocates the handle in left/right directions.

### PRIOR ART LITERATURE

### Patent Document

Patent Document 1: KR 10-0316401 B1

Patent Document 2: KR 10-1595841 B1

### SUMMARY

In order to solve the above problem, the present disclosure has an object to provide a leveling castor in which level adjustment means for leveling a weight is configured using a bevel gear, such that a height of the castor is adjusted via only a rotation of the means by a user.

The present disclosure provides a levelling castor comprising: a castor body having a socket shape having an bottom opening defined therein, wherein a wheel to be in contact with the ground is rotatably hinge-coupled to a bottom of the castor body; a connection frame rotatably connected to a top of the castor body and fixed to a bottom of a weight such that the castor body is coupled to the weight and is rotatable relative to the weight; a support body configured to extend from or retract into the castor body through the opening such that the support body contacts or is spaced from the ground; and vertical level adjustment means including a rotatable manipulator and a driven level adjuster.

In this connection, the rotatable manipulator includes: a rotatable shaft penetrating one side of the castor body toward an inner receiving space defined in the castor body; a rotatable handle connected to the rotatable shaft and exposed outwardly; and a rotatable gear connected to the rotatable shaft and disposed in the receiving space, wherein the driven level adjuster includes: a driven gear accommodated in the receiving space and connected to the rotatable gear in a bevel gear manner; and a level adjusting screw passing through and screw-engaged with the driven gear, wherein the level adjusting screw is configured to ascend or descend the support body based on rotation of the driven gear, wherein the driven gear rotates in association with rotation of the rotatable handle such that the driven gear rotates to allow the level adjusting screw to ascend or descend the support body.

In the leveling castor according to the present disclosure as configured as described above, the vertical level adjustment means for leveling the weight is configured using the bevel gear, such that the height of the castor is adjusted via only a rotation of the means by a user.

### BRIEF DESCRIPTION OF THE DRAWINGS

FIG. 1 is a front view showing a leveling castor according to the present disclosure.

FIG. 2 is a side view showing a leveling castor according to the present disclosure.

FIG. 3 is a cross-sectional view of an operating state of a leveling castor according to the present disclosure.

FIG. 4 is a perspective view of an operating state of a leveling castor according to the present disclosure.

### DETAILED DESCRIPTION

Hereinafter, preferred embodiments will be described in detail with reference to the accompanying drawings so that those with ordinary knowledge belonging to the same technical field may easily implement the present disclosure.

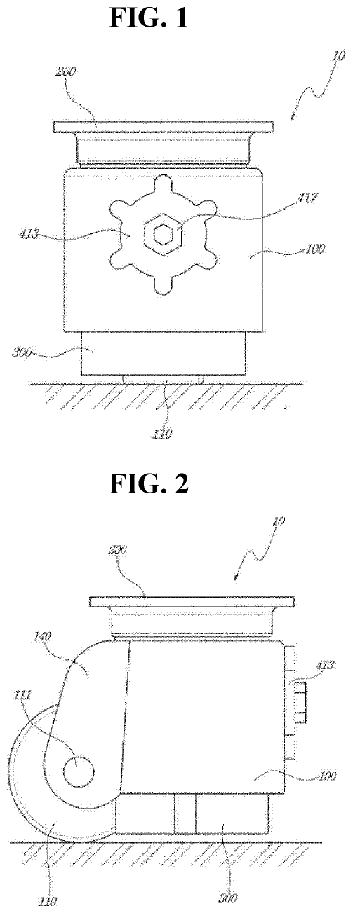

A leveling castor 10 according to the present disclosure, as shown in FIG. 1 to FIG. 4 may include a castor body 100 having a wheel 110a coupled thereto, a connection frame 200 for connecting the castor body 100 to a weight 20 and for supporting the weight, a support body 300 vertically extending from or retracting into a bottom opening 120 of the castor body 100, vertical level adjustment means to ascend and descend the support body 300.

In this connection, the castor body 100 has a socket shape having the bottom opening 120. The wheel 110 to be in contact with a ground is rotatably hinge-coupled to a bottom of the castor body 100.

In other words, a wheel bracket 140 protrudes from one side of the castor body 100, and a wheel shaft 111 of the wheel 110 is inserted into a wheel shaft hole 141 defined in a portion of the wheel bracket 140.

Therefore, a circumferential surface of the wheel 110 is in contact with the ground, so that the weight 20 may be easily moved to a desired position.

In addition, the weight 20 may be embodied as a plate on which heavy furniture, machinery or luggage is loaded. It is desirable that each leveling castor 10 according to the present disclosure is installed at each of four corners of the weight 20.

In this connection, the connection frame 200 is rotatably connected to a top of the castor body 100 and is fixed to a bottom of the weight 20. Thus, the connection frame 200 couples the castor body 100 to the weight 20 such that the castor body 100 rotates relate to the weight 20.

That is, when the connection frame 200 is fixed to the bottom surface of the weight 20 using fastening means such as bolts and pieces, the castor body 100 connected to the bottom of the connection frame 200 freely rotates so that an orientation of the wheel 110 follows a direction in which the weight 20 moves.

In one example, the support body 300 is configured to extend from or retract into the castor body 100 through the opening 120 such that the support body 300 contacts the ground.

Further, the vertical level adjustment means 400 is received in an inner receiving space 130 defined in the castor body 100. When the user rotates a rotatable handle 413 formed on an outer circumference of the castor body 100, the support body 300, the support body 300 may extend from or retract into the castor body 100 through the opening 120.

Therefore, in response to the manipulation of the vertical level adjustment means 400, the support body 300 moves up/down based on a reference plane (wheel bottom) at which the wheel 110 contacts the ground. When the user intends to move the weight 20 on the frame 200 to a desired position, the support body 300 moves up to a level above the reference plane and retracts into the castor body 100 through the opening 120. Then, when the weight 20 on the frame 200 has moved to the desired position and the user intends to fix a position of the weight 20 to the desired position, the support body 300 extends from the castor body 100 through the opening 120 such that the support body 300 moves down to a level below the reference plane and contacts the ground such that the wheel 110 is spaced from the ground.

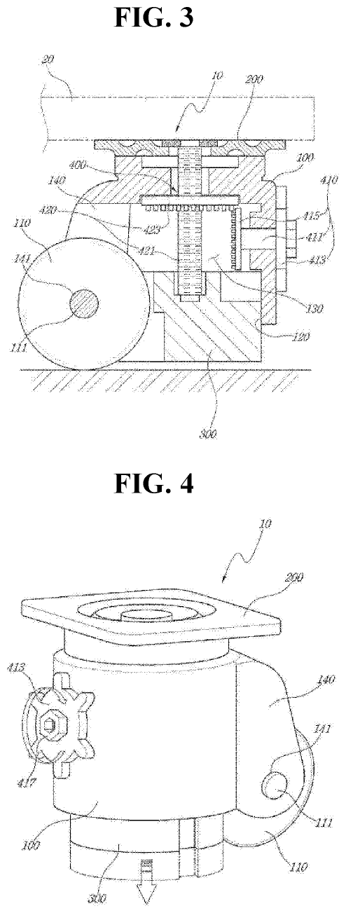

In one example, as shown in FIG. 3, the vertical level adjustment means 400 may include the rotatable manipulator 410 that the user arbitrarily rotates, and a driven level adjuster 4120 that rotates according to the rotation of the rotatable manipulator 410 to allow the support body 300 to ascend or descend.

In this connection, the rotatable manipulator 410 may include a rotatable handle 413 that a user rotates and is disposed on an outer face of the castor body 100, a rotatable shaft 411 passing through one side of the castor body 100 and having one end connected to the rotatable handle 413, and a rotatable gear 415 connected to the other end of the rotatable shaft 411.

In addition, the driven level adjuster 420 may include a driven gear 423 accommodated in the receiving space 130 and connected to the rotatable gear 415 in a bevel gear manner, and a level adjusting screw 421 passing through and rotatably coupled to the driven gear 423 to allow the support body 300 to ascend or descend based on the rotation of the driven gear 423.

In one example, a manipulation-assisting protrusion 417 is formed on the rotatable handle 413. Thus, when the user may not rotate the rotatable handle 413 due to the user's manual force, the user may use general tool such as a wrench or a hexagonal wrench to be fitted with the manipulation-assisting protrusion 417 to easily rotate the rotatable handle 413.

The level adjusting screw 421 penetrates the castor body 100. One end of the level adjusting screw 421 is coupled to the connection frame 200 and the other end thereof is coupled to the support body 300 in a thrust manner. Thus, the level adjusting screw 421 may serve as a central shaft for supporting a load of the weight 20.

Operation of the leveling castor 10 according to the present disclosure as constructed as described above will be described with reference to FIG. 3 and FIG. 4.

First, when the user rotates the exposed rotatable handle 413 protruding from one side of the castor body 100, the rotatable gear 415 rotates in the same direction around the rotatable shaft 411 and thus the driven gear 423 connected in a bevel gear manner thereto rotates.

In this connection, the level adjusting screw 421 passing through and coupled to the driven gear 423 moves vertically and downwardly in a screw manner according to the rotation of the driven gear 423. Thus, the support body 300 connected to the bottom of the level adjusting screw 421 in a thrust manner is pushed downwardly by the level adjusting screw 421 and moves downwardly to a level below the reference plane at which the wheel 110 contacts the ground. Thus, a position of the weight 20 is fixed.

Conversely, when the user rotates the rotatable handle 413 in the opposite direction, the rotatable gear 415 and the driven gear 423 rotate in the opposite direction to the above defined direction, thereby raising the level adjusting screw 421. The support body 300 moves upwardly to a level above the reference plane and then is accommodated in the opening 120. Eventually, the wheel 110 is brought into contact with the ground, so that the user may easily move the weight 20 to a desired position.

Providing the leveling castor 10 according to the present disclosure as configured as described above, non-skilled person may simply rotate the user the handle to easily and quickly adjust the height of the castor

The terms and words used in the present disclosure as described above and claims should not be construed as being limited to ordinary or lexical meanings. The terms and words used in the present disclosure as described above and claims should be interpreted as a meaning and concept consistent with the technical idea of the present disclosure, based on the principle that the present inventor may properly define the concept of terms in order to best explain the present disclosure.

Therefore, the configurations shown in the drawings and embodiments as described in the present specification is only one of the most preferred embodiments of the present disclosure, and does not represent all the technical ideas of the present disclosure. It should be understood that there may be various equivalents and variations that may be made when the present application is filed.

1. A levelling castor comprising:
a castor body having a socket shape having an bottom opening defined therein, wherein a wheel to be in contact with the ground is rotatably hinge-coupled to a bottom of the castor body;
a connection frame rotatably connected to a top of the castor body and fixed to a bottom of a weight such that the castor body is coupled to the weight and is rotatable relative to the weight;
a support body configured to extend from or retract into the castor body through the opening such that the support body contacts or is spaced from the ground; and
vertical level adjustment means including a rotatable manipulator and a driven level adjuster,
wherein the rotatable manipulator includes:
a rotatable shaft penetrating one side of the castor body toward an inner receiving space defined in the castor body;
a rotatable handle connected to the rotatable shaft and exposed outwardly; and
a rotatable gear connected to the rotatable shaft and disposed in the receiving space,
wherein the driven level adjuster includes:
a driven gear accommodated in the receiving space and connected to the rotatable gear in a bevel gear manner; and
a level adjusting screw passing through and screw-engaged with the driven gear,
wherein the level adjusting screw is configured to ascend or descend the support body based on rotation of the driven gear,
wherein the driven gear rotates in association with rotation of the rotatable handle such that the driven gear rotates to allow the level adjusting screw to ascend or descend the support body.
